(19) United States
(12) Patent Application Publication
(10) Pub. No.: US 2011/0059384 A1
(43) Pub. Date: Mar. 10, 2011

(54) ACTIVATION METHOD FOR MEMBRANE ELECTRODE ASSEMBLY, MEMBRANE ELECTRODE ASSEMBLY, AND SOLID POLYMER-TYPE FUEL CELL USING SAME

(76) Inventors: Yukihisa Okada, Tokyo (JP); Hideyuki Okada, Kanagawa (JP); Jiro Hattori, Kanagawa (JP)

(21) Appl. No.: 12/991,279

(22) PCT Filed: Apr. 14, 2009
(86) PCT No.: PCT/US09/40419

§ 371 Date: Nov. 5, 2010

(30) Foreign Application Priority Data
May 9, 2008 (JP) 2008-123338

(51) Int. Cl. H01M 8/10; H01M 8/00

(52) U.S. Cl. 429/479; 427/115

(57) ABSTRACT

In the conventional initial operation and activation processing (pre-processing), a processing time of ten odd hours or more is usually required, and special processing equipment and complex processing steps are needed. An aqueous alcohol solution is prepared, a membrane electrode assembly (10) for a solid polymer-type fuel cell is brought into contact with the aqueous alcohol solution, and the assembly (10) is then washed with water. Then, the membrane electrode assembly (10) is sandwiched between bipolar plates (30, 31) to configure a unit cell. The unit cell is sandwiched between collector plates (50, 51), a plurality of unit cells sandwiched between the collector plates are stacked, and the stack is tightened and held between insulating plates (60, 61) and end plates (70, 71) to produce a solid polymer-type fuel cell.

### FIELD OF TECHNOLOGY

The present invention relates to a solid polymer-type fuel cell, and more particularly to an activation method for a membrane electrode assembly for a solid polymer-type fuel cell.

### BACKGROUND ART

In the conventional fuel cells using a membrane electrode assembly, a high-performance cell output is difficult to obtain in the initial period after the cell actuation is started, and an initial operation of the cell in excess of several hours or activation processing of the cell (pre-processing) is usually performed. The activation processing is a process in which an ion conductive polymer used for the polymer electrolyte membrane in the membrane electrode assembly and an ion conductive polymer contained in an electrode catalyst layer are processed to obtain a state in which they contain water (hydrated state), and a structure in which the catalyst layer is suitable for power generation is then reassembled.

The initial operation and activation processing (pre-processing) is performed because the ion conductive polymer used for the polymer electrolyte membrane constituting the membrane electrode assembly that has been subjected to water repellent processing and the ion conductive polymer contained in the electrode catalyst layer function as electrolytes when they contain water (in a hydrated state) at the time the use thereof is started and, therefore, have to be humidified up to a dew point that is of the same order as the cell operation temperature when the fuel cell is to be operated at a high-performance cell output.

As an example of initial operation or activation processing (pre-processing) suggested for the conventional cells, Patent Document 1 describes a method by which an electric current is passed in the direction in which protons move from an anode electrode to a cathode electrode by using an external power source or an auxiliary power source, while supplying a fuel such as methanol to the anode electrode and supplying an inactive gas such as nitrogen to the cathode electrode, after the cell has been assembled. Further, Patent Document 2 describes a method by which an alcohol is introduced into a gas supply path of a cell assembly and then washed with deionized water.

Patent Document 1 Japanese Patent Application Laid-open No. 2006-40598, paragraph [0022], etc.

Patent Document 2 Japanese Patent Application Laid-open No. 2000-3718, paragraph [0008], etc.

### DISCLOSURE OF THE INVENTION

### Problems Addressed by the Invention

However, in the convention initial operation and activation processing (pre-processing), a processing time of ten odd hours or more is usually required and special processing equipment and complex processing steps are needed.

Accordingly, it is desirable that the activation processing of solid polymer-type fuel cells be conducted within a short time by using simple equipment and simple processing steps.

### Means for Resolving the Invention

The present invention provides a processing method of a membrane electrode assembly for a solid polymer-type fuel cell, comprising: a step of preparing an aqueous alcohol solution; a step of bringing a membrane electrode assembly into contact with the aqueous alcohol solution; and a step of washing the assembly that has been brought into contact with the aqueous alcohol solution.

The present invention also provides a membrane electrode assembly that has been processed by the above-described method.

Further, the present invention provides a solid polymer-type fuel cell using the membrane electrode assembly membrane electrode assembly that has been processed by the above-described method.

### EFFECT OF THE INVENTION

According to one aspect of the present invention, it is not necessary to introduce large-scale equipment such as gas supply equipment and gas humidifying equipment that has been conventionally necessary for the initial operation or activation processing of cells. In addition, the processing time can be shortened compared with conventional methods.

### BEST MODE FOR CARRYING OUT THE INVENTION

The main feature of the present invention resides in that a membrane electrode assembly for use in a solid polymer-type fuel cell is subjected to activation processing by merely bringing it into contact with an aqueous alcohol solution.

Examples of the membrane electrode assembly that is the object of the present invention include a membrane electrode assembly having a three-layer structure composed of one ion conductive layer and two electrode catalyst layers disposed on both sides thereof, and a membrane electrode assembly having a five-layer structure composed of one ion conductive layer, two electrode catalyst layers disposed on both sides thereof, and further two gas diffusion layers disposed on the outer periphery of the electrode catalyst layers. Here, the gas diffusion layer sometimes contains a microporous layer with the object of aiding the interface bonding with the electrode catalyst layer. The activation processing in accordance with the present invention can be adapted to either the three-layer structures or five-layer structures.

FIG. 1 is a cross-sectional view illustrating an example of a membrane electrode assembly having a five-layer structure. A membrane electrode assembly 10 shown in FIG. 1 has an ion conductive layer 11 that is a polymer electrolyte membrane, a cathode-side electrode catalyst layer 12 adjacent to one side of the ion conductive layer that is a polymer electrolyte membrane, and a cathode gas diffusion layer 3 adjacent to the cathode-side electrode catalyst layer 12 on the opposite side of the ion conductive layer 11 that is a polymer electrolyte membrane.

On the other side of the ion conductive layer 1 that is a polymer electrolyte membrane, there are provided an anode-side electrode catalyst layer 22 adjacent to the ion conductive layer 1 that is a polymer electrolyte membrane, and an anode gas diffusion layer 23 adjacent to the anode-side electrode catalyst layer 22 on the opposite side of the ion conductive layer 11 that is a polymer electrolyte membrane. The membrane electrode assembly 10 is formed by tightly bonding these layers together, for example, by using thermal press fusion. Further, the membrane electrode assembly 10 has a gasket 4 in order to prevent the fuel gas from leaking.

In one aspect of the present invention, it is preferred that the ion conductive polymer in the polymer electrolyte membrane of the ion conductive layer 11 of the membrane electrode assembly used herein and the ion conductive polymer in the electrode catalyst be composed of a material or have a structure that is resistance to swelling in water or alcohol. Perfluorosulfonic acid/PTFE copolymer-type materials represented by Nafion manufactured by Dupont Corp. have been used as ion conductive polymers, but by using materials that have higher resistance to swelling in water or alcohols, it is possible to prevent the occurrence of external appearance defects such as bulging and peeling in the membrane electrode assembly when the membrane electrode assembly is immersed into alcohol water. Hydrocarbon materials are preferred as materials with a comparatively high resistance to swelling in water or alcohols. Examples of hydrocarbon materials include sulfonated polyimides, polyphenylenes, ether sulfone, ether ether ketone, benzimidazole, and thiophenylene. Other examples include the so-called microporous filling electrolyte membrane materials in which an ion conductive polymer having a sulfonic acid is chemically retained in a hydrocarbon matrix. These materials demonstrate lower degree of swelling in water or alcohols and ensure higher resistance of the laminated structure of membrane electrode assembly to fracture (interlayer peeling resistance) than Nafion manufactured by Dupont Corp.

On the other hand, even when Nafion manufactured by Dupont Corp. is used, the processing in accordance with the present invention can be advantageously implemented by adjusting the alcohol concentration and selecting the temperature thereof.

Fine particles of noble metals represented by platinum or fine particles of transition metals such as Ni, Fe, and Co are used as the catalyst in the electrode catalyst layers 12, 22 of the membrane electrode assembly, and the catalyst is used in the form of a catalyst power in which the fine particles are supported on a carrier such as a carbon powder.

The electrode catalyst layers 12, 22 are formed by mixing the catalyst powder with a solution containing an ion conductive polymer to obtain a paste, coating the paste on the surface of a polymer electrolyte membrane, and fixing the coating by a hot pressing method or the like.

The activation processing of the membrane electrode assembly in accordance with one aspect of the present invention includes a step of preparing an aqueous alcohol solution, a step of bringing a membrane electrode assembly into contact with the aqueous alcohol solution, and a step of washing the membrane electrode assembly that has been brought into contact with the aqueous alcohol solution.

In the activation processing in accordance with one aspect of the present invention, any of alcohols with different numbers of carbon atoms, such as methanol, ethanol, and propanol, can be used as the aqueous alcohol solution, but when methanol is used: (1) the catalyst poisoning effect is the lowest and reversible, and (2) the molecules are small and good permeation property can be obtained. An embodiment of the present invention will be explained below with aqueous methanol solutions serving as examples.

Aqueous methanol solutions are prepared such that the alcohol concentration is 1 part by weight or more, 5 parts by weight or more to 100 parts by weight or less, and 50 parts by weight or less per 100 parts by weight of water. The hydration of ion conductive polymer within these concentration ranges of aqueous solutions can be enhanced by the action of alcohol component.

The temperature of the aqueous methanol solution can be maintained within a range of from 10° C. to a boiling point, or from 30° C. to 90° C. according to application, or from 40° C. to 70° C. according to application. Such water temperature can enhance the hydration of ion conductive polymer at the above-described concentration of aqueous solutions. Further, when the water temperature is high, the processing time can be shortened.

The actual temperature of aqueous solution is taken as an optimum temperature that is appropriately determined by also taking into account the specific phenomena such as thermal damage of structural members of the membrane electrode assembly.

A method by which the membrane electrode assembly is immersed in the aqueous alcohol solution is mainly used for bringing the membrane electrode assembly into contact with the aqueous alcohol solution, but a method by which the droplets of the aqueous alcohol solution are sprayed on the membrane electrode assembly and a method by which the membrane electrode assembly is held in vapors of the aqueous alcohol solution can be also used.

When the immersion method is employed, the processing time required to hydrate the ion conductive polymer is set at least equal to or longer than the time that is determined by a preliminary examination conducted with respect to the specific configuration of membrane electrode assembly and holding conditions of the aqueous alcohol solution.

For example, when the alcohol is methanol and an aqueous solution is used that contains 10 parts by weight of the alcohol per 100 parts by weight of water, where the holding temperature is taken as 65° C., the holding time can be 60 min.

In order to perform the activation processing with even higher efficiency, ultrasonic vibrations can be applied to the aqueous alcohol solution when the membrane electrode assembly is immersed thereinto. Further, the gas pressure inside the container that contains the aqueous alcohol solution can be reduced.

After holding in the aqueous alcohol solution, the membrane electrode assembly is washed with water (ion-exchange water) or the like. Where the alcohol remains in portions of the membrane electrode assembly, for example, in the electrode catalyst layer, a combustion reaction of the alcohol and oxygen contained in the air is induced by the catalytic action, and the corresponding portions of the membrane electrode assembly can be degraded by the combustion heat. The aforementioned washing can prevent such degradation.

For example, the washing can be advantageously performed by the following method.

Thus, first, after the time assumed to be necessary to complete the activation processing of the membrane electrode assembly immersed in the aqueous alcohol solution elapses, the aqueous alcohol solution is diluted by adding water (ion-exchange water), and the alcohol concentration is reduced to 0.01 part by weight or less of the alcohol per 100 parts by weight of water. Then, the membrane electrode assembly is removed from the diluted aqueous alcohol solution and immediately immersed in water (ion exchange water) that has been prepared separately.

With such method, the atmospheric exposure of a high-concentration alcohol component remaining in the membrane electrode assembly can be avoided and the remaining alcohol can be completely removed from the membrane electrode assembly.

In the membrane electrode assembly that has been activation processed in accordance with the present invention, the ion conductive polymer used in the polymer electrolyte membrane and the ion conductive polymer contained in the electrode catalyst layer are impregnated with water by the immersion processing in the aqueous alcohol solution.

Further, the internal resistance of the membrane electrode assembly can be assumed to reach a stationary state after the immersion. Here, the stationary state is determined as a state in which an inductance of the membrane electrode assembly subjected to immersion treatment that is measured by using an evaluation cell becomes equal to or less than an index value depending on the cell temperature. The internal resistance being equal to or less than the index value means that the ion conductive polymer of the membrane electrode assembly contains water and has already been sufficiently activated.

The impedance measured using an evaluation cell means a resistance value measured with an alternating current of 1 kHz or 10 kHz. This evaluation value can be obtained, for example, by using an evaluation cell for 25 cm² manufactured by Fuel Cell Technology Co., Ltd. (5620 Venice Blvd., NE, Suite F Albuquerque, N.Mex. 87113) and an impedance measurement device, model 356E, manufactured by Tsuruga Electric Corp. (Osaka, Sumiyoshi-ku). The measurement method involves setting a membrane electrode assembly in an evaluation measurement cell, supplying an aqueous solution of methanol to the anode side, and clamping the measurement terminals of the impedance measurement device to the anode and cathode electrodes in a state in which the cell outlet on the cathode side is closed.

In the above-described processing, for example, an aqueous solution using water (ion-exchange water) and special grade methanol for industrial applications is employed as the aqueous methanol solution and the measurements are conducted at a temperature of 40° C. The index value is a resistance value calculated per unit surface area. For example, when the measurement value for (A)cm² is (B)Ω, a value of (A)×(B) is used.

A specific numerical value of the index value is affected by various factors such as the configuration of membrane electrode assembly, shape and surface area of the cell, concentration of the aqueous alcohol solution used, and measurement temperature, but the index value can be determined by fixing all these factors.

Further, in the membrane electrode assembly subjected to the activation processing in the configuration in which the ion conductive layer is composed from a hydrocarbon material, for example, a material containing an ion conductive polymer of a hydrocarbon system or a material in which an ion conductive polymer is chemically held in a hydrocarbon matrix, the ion conductive polymer located in the assembly is in a hydrated state, no swelling caused by the alcohol and water is observed, and good bonding of the ion conductive layer, electrode catalyst layer, and gas diffusion layer that is unaffected by the immersion is maintained.

The solid polymer-type fuel cell in accordance with the present invention is composed of the membrane electrode assembly subjected to activation processing, a bipolar plate, a collector plate, and also an insulating plate, and an end plate.

For example, FIG. 2 is a cross-sectional view of a typical solid polymer-type fuel cell 100 showing a fuel cell using the membrane electrode assembly in accordance with the present invention. The solid polymer-type fuel cell 100 shown in FIG. 2 is configured by sandwiching a membrane electrode assembly 10 in a hydrated state thereof between bipolar plates 30, 31 having gas supply channels, taking the resultant cell as a unit cell, and successively sandwiching one unit cell or a plurality thereof between collector plates 50, 51, insulating plates 60, 61, and end plates 70, 71.

The solid polymer-type fuel cell assembly of the above-described configuration is fabricated by the following procedure.

1. First, the membrane electrode assembly 10 for a solid polymer-type fuel cell that has been fabricated by the above-described method is prepared.

2. Then, the membrane electrode assembly is sandwiched between the bipolar plates 30, 31 having gas supply channels to configure a unit cell.

3. The unit cell is sandwiched between the collector plates 50, 51, then a plurality of unit cells sandwiched between the collector plates are stacked, and the stack is sandwiched between and tightened by insulating plates 60, 61 and end plates 70, 71 so as to obtain a predetermined surface pressure (about 20 kg/cm²).

### EXAMPLES

Examples of the present invention will be described below in greater detail, but it is apparent to a person skilled in the art that various modifications and changes in the below-described embodiments can be made within the scope defined in the claims of the present application.

### 1. Fabrication of Samples

A membrane electrode assembly to be subjected to activation processing of an example of the present invention was fabricated by the following procedure. In the fabrication of the assembly, a polymer using a Perfluorosulfonic acid/PTFE copolymer material (more specifically, Nafion manufactured by Dupont Corp.) (sample A) and a polymer using a hydrocarbon material (microporous filling membrane with a polyethylene matrix) (sample B) were fabricated.

### (1) Fabrication of Sample A

First, as the noble catalyst particles, conductive carbon particles with a mean primary particle size of 30 nm that supported platinum at 50 wt. % were used as catalyst supporting particles for the air electrode side, and carbon particles that supported a platinum—ruthenium alloy with an atomic ratio of 1:1 at 50 wt. % were used as the catalyst supporting particles for the fuel electrode side. Then, these catalyst supporting particles were dispersed together with an ion conductive polymer by using 20% Nafion Dispersion Solution DE2020 of Wako 325-46423 manufactured by Wako Pure Chemical Industries, Ltd., which is a dispersion, to obtain an ink paste for a cathode catalyst (air electrode side) or a catalyst ink paste for an anode catalyst (fuel electrode side). The content of the ion conductive polymer in the catalyst ink was adjusted to obtain 25 wt. %.

These catalyst ink pastes were coated by using a bar coater on polypropylene sheets with a thickness of 100 μm and dried by holding for 1 h at 60° C. Then, the polypropylene sheet with the anode catalyst attached thereto and the polypropylene sheet with the cathode catalyst attached thereto were disposed on both surfaces of a polymer electrode membrane made from Nafion® 115 manufactured by Dupont Corp., and thermally transferred in a hot press machine. The polypropylene sheets were then peeled off and removed to obtain a membrane electrode assembly.

The surface area of the catalyst layer was 25 cm², and the layer had a square shape with a length of one side of 5 cm.

Then, carbon paper TGP-H-090 manufactured by Toray Industries, Inc. was used as the base material for a gas diffusion layer, immersed for 1 min in a solution prepared by diluting FEP Dispersion ND-1 manufactured by Daikin

Industries, Ltd., pulled up, dried in a hot-air drier at 120° C., and subjected to calcination processing for 2 h in an electric furnace at 300° C. The content of a water-repelling agent in this process was 5%.

### (2) Fabrication of Sample B

A sample B was fabricated by the same fabrication procedure as that of sample A, except that the ion conductive polymer portion was a hydrocarbon material (microporous filling membrane with a polyethylene matrix) instead of Nafion.

### 2. Pre-Processing (Activation Processing) of Samples

### Example 1

An aqueous methanol solution containing 8 parts by weight of methanol per 100 parts by weight of water was prepared by using a reagent grade methanol and water (ion-exchange water). The fabricated membrane electrode assembly (sample A) was placed in a resealable vinyl packet with a capacity of 30 cc, about 6 cc of the aqueous solution of methanol, this amount being sufficient to completely immerse the mea, was introduced into the vinyl packet, and the reseal chuck was closed so as to minimize the amount of air remaining in the packet. The packet was placed into an oven controlled to 65° C. and heated for 20 min. The vinyl packet was then opened, and the aqueous solution of methanol was squeezed out and discharged from the vinyl packet so as to prevent the air from coming into contact with the membrane electrode assembly. About 30 cc of water (ion-exchange water) was then again introduced into the vinyl packet and poured out, and this operation was repeated five times. The membrane electrode assembly that was thus thoroughly rinsed by the above-described operation was taken out and lightly washed by shaking for about 5 sec in water (ion-exchange water).

### Example 2

The activation processing was conducted under the same conditions as those of Example 1, except that the heating time was changed to 60 min.

### Example 3

The activation processing was conducted under the same conditions as those of Example 1, except that the heating conditions were changed as follows: the heating temperature was 20° C. and the heating time was 18 h.

### Example 4

An aqueous methanol solution containing 4 parts by weight of methanol per 100 parts by weight of water was prepared by using a reagent grade methanol and water (ion-exchange water). The fabricated membrane electrode assembly (sample B) was placed in a resealable vinyl packet with a capacity of 30 cc, about 6 cc of the aqueous solution of methanol, this amount being sufficient to completely immerse the membrane electrode assembly, was introduced into the vinyl packet, and the packet was sealed so as to minimize the amount of air remaining in the packet. The packet was allowed to stay for 18 h in a room at about 20° C. The vinyl packet was then opened, and the aqueous solution of methanol was squeezed out and discharged from the vinyl packet so as to prevent the air from coming into contact with the membrane electrode assembly. About 30 cc of water (ion-exchange water) was then again introduced into the vinyl packet and poured out, and this operation was repeated five times. The membrane electrode assembly that was thus thoroughly rinsed by the above-described operation was taken out and lightly washed by shaking for about 5 sec in water (ion-exchange water).

### Comparative Example 1

The fabricated membrane electrode assembly (sample A) was not subjected to any pre-processing (activation processing).

### Comparative Example 2

The fabricated membrane electrode assembly (sample A) was set in a characteristic evaluation cell, an aqueous solution of methanol (concentration: 8 parts by weight of alcohol per 100 parts by weight of water) was supplied at the same temperature to the anode electrode in the same manner as in the above-described impedance measurements, and the cathode was shielded from air. The evaluation cell was heated to 65° C. in this state, and five cycles of a constant-voltage test were repeated in this state, while supplying the atmospheric air at 100 cm/min to the cathode. The constant-voltage test is a test in which a voltage is swept from 0.7 V at a rate of 0.1 V per 2 mV/sec and held for 30 sec at 0.1 V. This test was repeated.

The membrane electrode assembly was then set in the evaluation cell and the impedance measurements were conducted by the above-described method.

### Comparative Example 3

The fabricated membrane electrode assembly (sample B) was not subjected to any pre-processing (activation processing).

### 3. Method for Measuring Impedance of Sample

The impedance of the pre-processed membrane electrode assembly was measured using an impedance measurement device, model 356E, manufactured by Tsuruga Electric Corp. (Osaka, Sumiyoshi-ku), by placing the membrane electrode assembly in an evaluation cell for 25 cm² manufactured by Fuel Cell Technology Co., Ltd. (5620 Venice Blvd., NE, Suite F Albuquerque, N.Mex. 87113). In this case, the measurements were conduced at an alternating current of 10 kHz by supplying an aqueous solution of methanol (concentration: 8 parts by weight of alcohol per 100 parts by weight of water) at 1.5 cm/min and the same temperature to the anode, closing the cell outlet at the cathode side, and clamping the measurement terminals of the impedance measurement device on the anode and cathode electrodes in a state in which the air was shielded.

### 4. Results Obtained in Measuring Impedance and Output Characteristic

Table 1 shows the impedance measurement values (values calculated for a unit surface area at a measurement frequency of 10 kHz) obtained by mounting the membrane electrode assemblies obtained in Examples 1 to 4 and Comparative Examples 1, 2 by conducting measurements immediately thereafter at room temperature 25° C. and 40° C. In this case, the measurements were performed by supplying an aqueous solution of methanol (concentration: 8 parts by weight of alcohol per 100 parts by weight of water) at 1.5 cm/min and the same temperature to the anode electrode, and shielding the air on the cathode side.

Here, the activation processing was determined to be completed when the impedance control value was equal to or less than 250 mΩ/cm² at 40° C. and equal to or less 400 mΩ/cm² at 25° C.

TABLE 1

| | | | | | Comparative | Comparative |
|---|---|---|---|---|---|---|
| | Example 1 | Example 2 | Example 3 | Example 4 | Example 1 | Example 2 |
| | mΩ/cm² | mΩ/cm² | mΩ/cm² | mΩ/cm² | mΩ/cm² | mΩ/cm² |
| 25° C. | 384 | 336 | 342 | 350 | 3000 or | 550 |
| | | | | | more | |
| 40° C. | 241 | 217 | 220 | 220 | 3000 or | 425 |
| | | | | | more | |

Table 2 shows the impedance measurement values at 40° C. relating to the case in which the membrane electrode assemblies obtained in Example 1 and Comparative Example 2 were mounted inside the evaluation cells and held therein for 7 days. The variation of the impedance measurement value after holding for about 1 week in Example 1 was less than that in Comparative Example 2.

TABLE 2

| | After 1 day | After 3 days | After 5 days | After 7 days |
|---|---|---|---|---|
| | mΩ/cm² | mΩ/cm² | mΩ/cm² | mΩ/cm² |
| Example 1 | 236 | 232 | 227 | 221 |
| Comparative | 390 | 379 | 346 | 332 |
| Example 2 | | | | |

Table 3 shows the output characteristics at 40° C. of fuel cells using the membrane electrode assemblies obtained in Example 1 and Comparative Example 2. The output characteristic of the fuel cell using the membrane electrode assembly of Example 1 that was subjected to the activation processing in accordance with the present invention was higher than that of the fuel cell using the membrane electrode assembly of Comparative Example 2.

TABLE 3

| | After 1 day | After 3 days | After 5 days | After 7 days |
|---|---|---|---|---|
| | mW/cm² | mW/cm² | mW/cm² | mW/cm² |
| Example 1 | 59 | 61 | 61 | 63 |
| Comparative | 25 | 29 | 31 | 39 |
| Example 2 | | | | |

FIG. 3 shows the results obtained in measuring the output current at 0.75 V and an impedance obtained in 10 cycles, where an electric potential scanning of 0.9 V-0.4 V and a low voltage of 0.5 V applied for 15 min each, that is, for a total of 30 min, are taken as one cycle. The measurements were conducted by setting the membrane electrode assemblies obtained in Example 4 and Comparative Example 3 in the characteristic evaluation cell and supplying hydrogen to the anode and air to the cathode at a temperature of 70° C. via a bubbler controlled to 70° C.

Further, FIG. 4 shows the measurement results of impedance corresponding to corresponding to the output current measurement time in FIG. 3.

As for the transition of the impedance measurement value shown in FIGS. 3 and 4, in Example 4 and Comparative Example 3, the difference was very small, but the impedance measurement value of the membrane electrode assembly in Example 4 that was subjected to the activation processing, was small both as the initial value in the first cycle and as the value of the tenth cycle. The evaluation value of the output characteristic was higher in the initial state, after the usual activation, and also after the activation processing.

As for the transition of the output current, in the membrane electrode assembly of Example 4, the increase was by a factor of about 1.5 with respect to the initial output current, the saturation level of the current was reached after six cycles, the output was saturated faster when the activation processing was performed than in the case of an unprocessed membrane electrode assembly of Comparative Example 3, and the output reached was higher than that in the unprocessed product.

### BRIEF DESCRIPTION OF THE DRAWINGS

FIG. 1 is a cross-sectional view illustrating an example of the membrane electrode assembly of a five-layer structure in accordance with the present invention.

FIG. 2 is a fuel cell using the membrane electrode assembly in accordance with the present invention.

FIG. 3 is a diagram illustrating the relationship between the output current and cycles of the membrane electrode assembly in accordance with the present invention.

FIG. 4 is a diagram illustrating the relationship between the impedance measurement value and cycles of the membrane electrode assembly in accordance with the present invention.

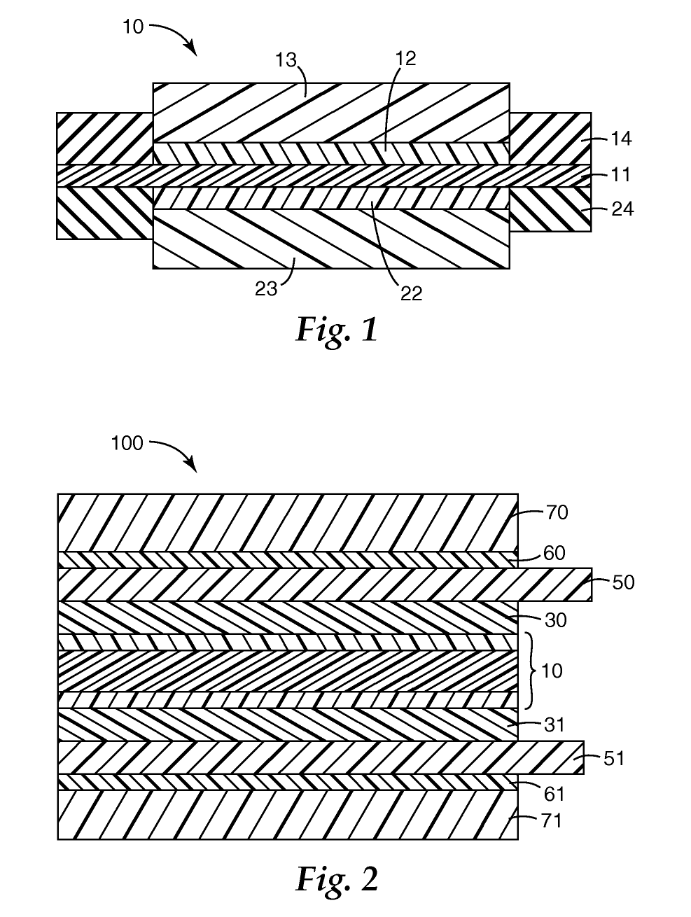

### EXPLANATION OF KEYS

10 membrane electrode assembly

11 polymer electrolyte membrane

12 cathode-side electrode catalyst layer

13 cathode-side gas diffusion layer

14, 24 gasket

22 anode-side electrode catalyst layer

23 anode-side gas diffusion layer

100 solid polymer fuel cell

30, 31 bipolar plate

50, 51 collector

60, 61 insulating plate

70, 71 end plate

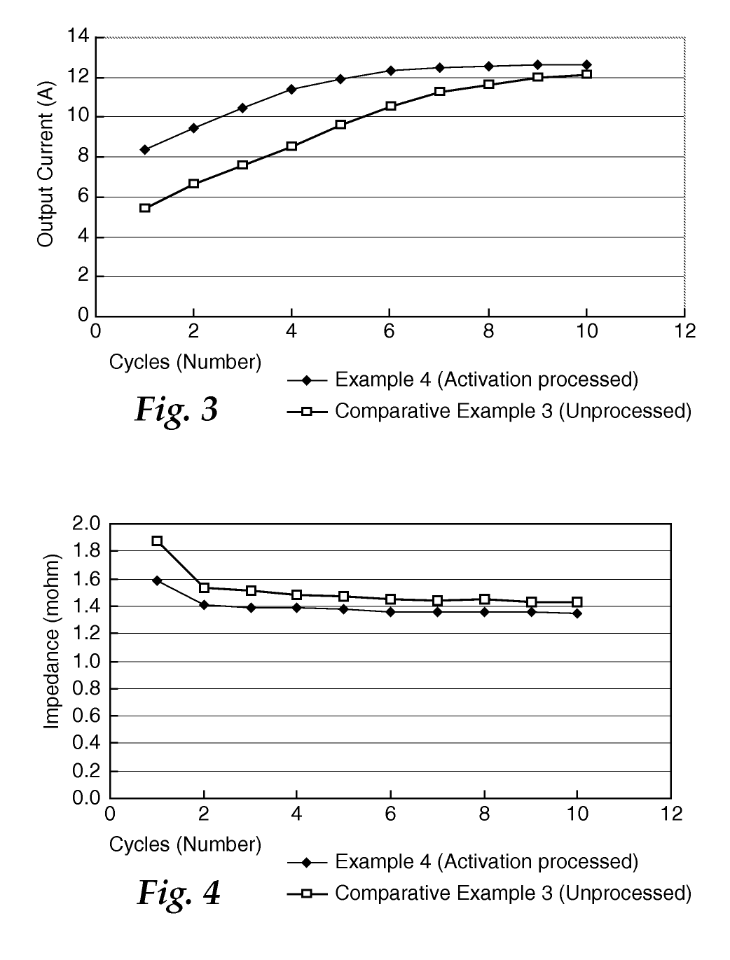

IN FIG. 3, Data Marked “Activation Processed” Relate To Example 4, And Those Marked “Unprocessed” Relate To Comparative Example 3.

IN FIG. 4, Data Marked “Activation Processed” Relate To Example 4, And Those Marked “Unprocessed” Relate To Comparative Example 3.

1. An activation processing method of a membrane electrode assembly, comprising:
a step of preparing an aqueous alcohol solution;
a step of bringing a membrane electrode assembly into contact with the aqueous alcohol solution; and
a step of washing the assembly that has been brought into contact with the aqueous alcohol solution.

2. The activation processing method of a membrane electrode assembly according to claim 1, wherein in the step of bringing the membrane electrode assembly into contact with the aqueous alcohol solution, a concentration of the aqueous alcohol solution is 1 part by weight to 100 parts by weight of alcohol per 100 parts by weight of water, and a temperature of the aqueous solution is within a range of from 10° C. to a boiling temperature.

3. The activation processing method of a membrane electrode assembly according to claim 1, wherein the aqueous alcohol solution is an aqueous methanol solution.

4. The activation processing method of a membrane electrode assembly according to claim 1, wherein the membrane electrode assembly has an ion conductive layer composed of a hydrocarbon material.

5. A membrane electrode assembly processed by the activation processing method of claim 1.

6. (canceled)

7. The-activation processing method of a membrane electrode assembly according to claim 2, wherein the aqueous alcohol solution is an aqueous methanol solution.

8. The activation processing method of a membrane electrode assembly according to claim 2, wherein the membrane electrode assembly has an ion conductive layer composed of a hydrocarbon material.

9. The activation processing method of a membrane electrode assembly according to claim 3, wherein the membrane electrode assembly has an ion conductive layer composed of a hydrocarbon material.

10. The activation processing method of a membrane electrode assembly according to claim 4, wherein the membrane electrode assembly has an ion conductive layer composed of a hydrocarbon material.

11. A membrane electrode assembly processed by the activation processing method of claim 2.

12. A membrane electrode assembly processed by the activation processing method of claim 3.

13. A membrane electrode assembly processed by the activation processing method of claim 4.

14. A membrane electrode assembly processed by the activation processing method of claim 5.

15. A membrane electrode assembly processed by the activation processing method of claim 6.

16. A membrane electrode assembly processed by the activation processing method of claim 7.

17. A membrane electrode assembly processed by the activation processing method of claim 8.
